(19) United States
(12) Patent Application Publication
(10) Pub. No.: US 2021/0324497 A1
(43) Pub. Date: Oct. 21, 2021

(54) Thermally Stable Silver Alloy Coatings

(71) Applicant: Umicore Galvanotechnik GmbH, Schwaebisch Gmuend (DE)

(72) Inventor: Bernd WEYHMUELLER, Alfdorf Hintersteinenberg (DE)

(21) Appl. No.: 17/272,528

(22) PCT Filed: Oct. 21, 2019
(86) PCT No.: PCT/EP2019/078475

§ 371 Date: Mar. 1, 2021

(30) Foreign Application Priority Data
Oct. 22, 2018 (DE) 10 2018 126 174.8

(51) Int. Cl. C22C 5/06; C25D 3/64

(52) U.S. Cl. CPC C22C 5/06; C25D 3/64

(57) ABSTRACT

The present invention is directed to the electrolytic deposition of an alloy predominantly containing silver. Further constituents of the deposited alloy layer are palladium, tellurium and one or more of the metals Ce, Dy, Pb, Bi, Al, Ga, Ge, Fe, In, Co, Ni, Cu, Sn, Sb, Rh, Ru, Ir, Pt, Au. The present invention also relates to a method for the electrolytic deposition of a corresponding layer using a suitable electrolyte. The use of the electrolytically deposited alloy layer is also claimed.

The present invention is directed to the electrolytic deposition of an alloy predominantly containing silver. Further constituents of the deposited alloy layer are palladium, tellurium and one or more of the metals Ce, Dy, Pb, Bi, Al, Ga, Ge, Fe, In Co, Ni, Cu, Sn, Sb, Rh, Ru, Ir, Pt, Au. The present invention also relates to a method for the electrolytic deposition of a corresponding layer using a suitable electrolyte. The use of the electrolytically deposited alloy layer is also claimed.

Electrical contacts are used today in virtually all electrical appliances. Their applications range from simple plug connectors to safety-relevant, sophisticated switching contacts in the communications sector, for the automotive industry or for aerospace technology. Here the contact surfaces are required to have good electrical conductivity, low contact resistance with long-term stability, good corrosion and wear resistance with as low as possible insertion forces as well as good resistance to thermal stress. In electrical engineering, plug contacts are often coated with a hard-gold alloy layer, consisting of gold-cobalt, gold-nickel or gold-iron. These layers have a good resistance to wear, a good solderability, a low contact resistance with long-term stability, and good corrosion resistance. Due to the rising price of gold, less expensive alternatives are being sought.

As a substitute for hard-gold plating, coating with silver-rich silver alloys (hard silver) has proven advantageous. Silver and silver alloys are amongst the most important contact materials in electrical engineering, not only on account of their high electrical conductivity and good oxidation resistance. These silver-alloy layers have, depending on the metal that is added to the alloy, layer properties similar to those of currently used hard-gold layers and layer combinations, such as palladium-nickel with gold flash. In addition, the price for silver is relatively low compared with other precious metals, in particular hard-gold alloys.

One constraint on the use of silver is, for example, the fact that, in atmospheres containing sulfur or chlorine, silver has lower corrosion resistance than hard gold. Apart from the visible surface change, tarnishing films of silver sulfide in most cases do not represent any great danger since silver sulfide is semi-conductive, soft and during the insertion process is easily wiped away, provided contact forces are strong enough. Tarnishing films of silver chloride, on the other hand, are non-conductive, hard and not easily displaced. A relatively high proportion of silver chloride in the tarnishing layers thus leads to problems with the contact properties (literature: Marjorie Myers: Overview of the use of silver in connector applications; Interconnect & Process Technology, Tyco Electronics, Harrisburg, February 2009).

Other metals may be alloyed to the silver to increase corrosion resistance. A possible alloying partner for silver in this connection is the metal palladium. Silver-palladium alloys are, for example, sulfur-resistant if the palladium content is correspondingly high (DE2914880A1).

Palladium-silver alloys have been used successfully for a long time as contact material in the form of wrought alloys. In relay switching contacts, 60/40 palladium-silver alloys are preferably used as an inlay. Nowadays, these coatings of electrical contact materials that are based on precious metals are preferably also produced galvanically. Although the electrochemical deposition of the palladium-silver alloy layers of mostly alkaline electrolytes has already been well investigated, it has not yet been possible to develop practicable electrolytes, partly because the deposited palladium-silver alloy layers did not meet quality and composition requirements. The previous use of acidic electrolytes described in the literature and patents is based mostly on thiocyanate, sulfonate, sulfate, sulfamate, or nitrate electrolytes. However, many electrolytes often still suffer from a lack of stability of the electrolyte system (Edelmetallschichten, H. Kaiser, 2002, p. 52, Eugen G. Leuze Verlag).

DE102013215476B3 describes the electrolytic deposition of an alloy predominantly containing silver. Further alloying constituents are palladium, tellurium or selenium. The alloy layers described here show aging effects, especially at high temperatures, which lead to increased cracking.

It is, therefore, an object of the present invention to provide novel and temperature-stable alloy layers which can be produced simply by electrolytic deposition and are superior to the corresponding alloys of the prior art. Especially when it comes to production, the alloy layers according to the invention should have advantages over the known alloy layers which predominantly contain silver and furthermore comprise palladium and tellurium as constituents.

These and other tasks that are obvious to a person skilled in the art based on prior art are solved by an alloy layer and a corresponding method for its production having the features of the present claims 1 and 7. The dependent claims dependent on these claims relate to preferred embodiments of the present invention. Claim 11 is directed to preferred uses.

The present task very surprisingly is solved by producing an electrolytically deposited silver-palladium alloy layer predominantly containing silver and having less than or equal to 20 at % tellurium relative to the entire alloy layer, which additionally comprises one or more of the metals Ce, Dy, Pb, Bi, Al, Ga, Ge, Fe, In, Co, Ni, Cu, Sn, Sb, Rh, Ru, Ir, Pt, Au. Such an alloy layer has a high corrosion resistance. Furthermore, it has improved temperature stability and a corresponding electrolyte will not lead to cracking even at high current densities during the electrolytic deposition of the alloy according to the invention (see Table 1).

Electrolytically deposited silver-palladium alloy layers predominantly containing silver and comprising tellurium are familiar to the person skilled in the art (AgPdTe alloy). However, electrolytically produced silver-palladium alloy layers predominantly containing silver and having less than or equal to 20 at % tellurium relative to the entire alloy layer, which additionally comprise one or more of the metals Ce, Dy, Pb, Bi, Al, Ga, Ge, Fe, In, Co, Ni, Cu, Sn, Sb, Rh, Ru, Ir, Pt, Au, are novel for a person skilled in the art. Preferably, such AgPdTe alloy layers additionally comprise the metals Ce, Dy, Pb, Bi, In, Sn and/or Fe. In this context, particular preference should be given to metals belonging to the Bi, Pb, Ce group for use as additional metals. Bi is very particularly preferable in this context.

In an advantageous embodiment, the additional metal or metals should be present in an amount of less than or equal to 40 at % in the AgPdTe alloy layer. Preferably, only one additional metal is present in this amount. The particularly preferable amount of the additional metal is 0.1-20 at %, more preferably 0.5-10 at % and very particularly preferably 0.5-5 at %. In individual cases, smaller amounts of less than 2 at % also suffice.

Silver is the main constituent of this electrolytically produced alloy. The alloys deposited according to the invention have a composition which has about 50-95 at % silver (preferably sole rest: palladium and tellurium and the additional metals). According to the invention, the concentrations in the electrolyte of the metals to be deposited are set within the framework given above in such a way that the result is a silver-rich alloy. It should be noted that it is not only the concentration of the metals to be deposited that has an influence on the silver concentration in the deposited alloy but it is also the current density used, the amount of sulfonic acid used and the amount of tellurium compound added. However, the person skilled in the art will know how to set the corresponding parameters in order to obtain the target alloy desired or will be able to determine this by routine experiments. The preferable target alloy is an alloy in which silver has a concentration of more than 60 at %, more preferably between 70 and 99 at %, further preferably 75-97 at % and most preferably 85-95 at %.

Preferably, the alloy layer according to the invention has 0.1-30 at % palladium. However, sufficient palladium should be present for a corresponding corrosion resistance. Generally, alloy layers with 1-20 at %, more preferably 2-15 at % and most preferably 3-12 at % palladium content are suitable.

A further component of the alloy according to the invention is tellurium. It is represented in the alloy preferably in a concentration of 0.1-10 at %, preferably 1-5 at % and very preferably 2-4 at %.

The alloy layer according to the invention is superior to known electrolytically deposited AgPdTe alloys as regards abrasion resistance and hardness (measured according to DIN EN ISO 6507-1:2018). The alloy layers according to the claims have a hardness of >250 Hv, preferably >260 Hv and very preferably >270 Hv, depending on the alloy composition.

In a further embodiment, the present invention relates to a method for the electrolytic deposition of a silver-palladium alloy layer predominantly containing silver which contain less than or equal to 20 at % tellurium relative to the entire alloy layer. The method is characterized in that an aqueous, acidic and cyanide-free electrolyte having the following composition is used:

a) a soluble silver salt, preferably as sulfonate,

b) a soluble palladium salt, preferably as sulfate,

c) a soluble tellurium salt in which tellurium has the oxidation state +4 or +6,

d) a soluble salt of one or more of the additional metals Ce, Dy, Pb, Bi, Al, Ga, Ge, Fe, In Co, Ni, Cu, Sn, Sb, Rh, Ru, Ir, Pt, Au, preferably as sulfonate,

e) at least one amino acid selected from the group consisting of:

alanine, aspartic acid, cysteine, glutamine, glutamic acid, glycine, lysine, leucine, methionine, phenylalanine, phenylglycine, proline, serine, tyrosine, valine.

The electrolyte used according to the invention contains salts of silver, palladium and tellurium and additionally one or more of the metals Ce, Dy, Pb, Bi, Al, Ga, Ge, Fe, In, Co, Ni, Cu, Sn, Sb, Rh, Ru, Ir, Pt, Au also in the form of a salt. These are preferably salts of the additional metals Ce, Dy, Pb, Bi, In, Sn and/or Fe. In this context, particular preference should be given to metals belonging to the Bi, Pb, Ce group for use as additional metals. Bi is very particularly preferable in this context.

The electrolyte according to the invention is used within an acidic pH range. Optimal results can be obtained with pH values of <2 in the electrolyte. The person skilled in the art will know how he can set the pH value of the electrolyte. It is preferably in the strongly acidic range, more preferably <1. It is most advantageous to choose extremely strongly acidic deposition conditions where the pH value is less than 0.8 and possibly may even reach 0.1 or even 0.01 in exceptional cases. Ideally, the pH value will be around 0.6. It may be the case that fluctuations occur in the pH value of the electrolyte during electrolysis. In one preferred embodiment of the present method, the person skilled in the art will therefore take steps to monitor the pH value during electrolysis and if necessary adjust it to the setpoint value.

In principle, the pH value can be adjusted according to the knowledge of the person skilled in the art. The person skilled in the art will be, however, guided by the idea of introducing as few additional substances into the electrolyte as possible that could adversely affect the deposition of the alloy in question. Therefore, in a particularly preferable embodiment, the pH value will be adjusted solely by adding sulfonic acid. The free sulfonic acid added is used in a sufficient concentration of 0.25-4.75 mol/l. The concentration is preferably 0.5-3 mol/l and most preferably 0.8-2.0 mol/l. The sulfonic acid serves firstly to establish an appropriate pH value in the electrolyte. Secondly, its use leads to a further stabilization of the electrolyte according to the invention. The upper limit of the sulfonic acid concentration is due to the fact that at too high a concentration only silver is deposited. In principle the sulfonic acids known to the person skilled in the art for use in electroplating technology can be used. Sulfonic acids are preferably selected from the group consisting of ethanesulfonic acid, propanesulfonic acid, benzenesulfonic acid, and methanesulfonic acid. Propanesulfonic acid and methanesulfonic acid are more particularly preferred in this context. Most particularly preferred is methanesulfonic acid.

The electrolyte used in the method according to the invention has a specific electrolyte density which can be selected by the person skilled in the art at his sole discretion. It is preferably between 1.0 and 1.5 at 23° C. A density of 1.0-1.3, most preferably 1.0-1.2, is particularly preferred. The density was determined gravimetrically.

The temperature prevailing during deposition of the alloy according to the invention can be selected as desired by the person skilled in the art. He will be guided on the one hand by an adequate deposition rate and an applicable current density range and on the other hand by cost aspects or the stability of the electrolyte. It is advantageous to set a temperature of 30° C. to 90° C. in the electrolyte. A use of the electrolyte at temperatures of 45° C. to 75° C. and very particularly preferably of 50° C.-70° C., most preferably of >60° C., appears to be particularly preferable.

The current density, which is established in the electrolyte between the cathode and the anode during the deposition process, can be selected by the person skilled in the art according to the efficiency and quality of deposition. Depending on the application and the type of coating plant, the current density in the electrolyte is advantageously set to 0.1 to 100 A/dm². If necessary, current densities can be increased or reduced by adjusting the system parameters, such as the design of the coating cell, flow rates, the anode or cathode set-ups, and so on. A current density of 0.25-50 A/dm², preferably 0.5-20 A/dm² and more preferably 1-15 A/dm² is advantageous. Most preferably, the current density is 2-12 A/dm².

The person skilled in the art will generally be familiar with the metal compounds which can be added to the electrolyte. Preferably, a salt of the silver which is soluble in the electrolyte can be used as the silver compound to be added to the electrolyte. It is very particularly preferable to select the salts from the group consisting of silver methane sulfonate, silver carbonate, silver sulfate, silver phosphate, silver pyrophosphate, silver nitrate, silver oxide, silver lactate. Here, too, the person skilled in the art should be guided by the principle that as few additional substances as possible should be added to the electrolyte. Therefore, the person skilled in the art will give preference to selecting sulfonate, more preferably methanesulfonate, as the silver salt to be added. As regards the concentration of the silver compound employed, the person skilled in the art should be guided by the limit values given above for the alloy composition. Preferably, the silver compound will be present in the electrolyte in a concentration of 0.01-2.5 mol/l of silver, more preferably 0.02-1 mol/l of silver and most preferably between 0.05 and 0.2 mol/l of silver.

The palladium compound to be employed is preferably also a salt soluble in the electrolyte or a soluble complex. The palladium compound used here is preferably selected from the group consisting of palladium hydroxide, palladium chloride, palladium sulfate, palladium pyrophosphate, palladium nitrate, palladium phosphate, palladium bromide, palladium P salt (diamminedinitrito palladium (II) ammoniacal solution) palladium glycinate, palladium acetate, palladium EDA complex, tetraammine palladium hydrogen carbonate. The palladium compound is added to the electrolyte at a concentration such that sufficient deposition takes place in the alloy layer. The palladium compound is preferably used in a concentration of 0.001-0.75 mol/l palladium, extremely preferably in a concentration of 0.01-0.2 mol/l palladium in the electrolyte.

The tellurium compound used in the electrolyte can be appropriately selected by the person skilled in the art within the framework of the desired concentration. A concentration between 0.05 and 80 mmol/l tellurium and quite particularly preferably between 0.5 and 40 mmol/l tellurium, can be selected as preferred concentration range. Those compounds of the tellurium which have the elements in the +4 and +6 oxidation state can be considered as compounds with which the electrolyte can be provided. Compounds in which said elements have the oxidation states +4 are particularly preferred. Very particular preference is given to those selected from the group consisting of tellurites, tellurous acid, telluric acid and tellurate in this context. Most preferable is the addition of tellurium to the electrolyte in the form of a salt of the tellurous acid.

Amino acids are used as complexing agents in the present electrolyte. Preferably the amino acids used here are those which have only alkyl groups in the variable residue. The use of amino acids, such as alanine, glycine and valine, is furthermore preferred. The use of glycine and/or alanine is most preferable. Within the concentration framework given above, the person skilled in the art can freely select the optimum concentration for the amino acid used. He will be guided by the fact that if the quantity of amino acid is too small it will not produce the stabilizing effect desired, while too high a concentration can inhibit the deposition of palladium and other alloy metals. It has, therefore, proven to be particularly advantageous if the palladium is added to the electrolyte directly as a corresponding palladium amino acid complex.

Various anodes can be employed when using the electrolyte. Soluble or insoluble anodes are just as suitable as the combination of soluble and insoluble anodes. If a soluble anode is used, a silver anode is particularly preferred.

Preferred insoluble anodes are those made of a material selected from the group consisting of platinized titanium, graphite, iridium-transition metal mixed oxide and special carbon material (DLC or diamond-like carbon) or combinations of these anodes. Platinized titanium or iridium tantalum mixed oxide are particularly preferably used for carrying out the invention. More information may be found in Cobley, A. J et al. (The use of insoluble anodes in acid sulphate copper electrolytic deposition solutions, Trans IMF, 2001, 79(3), pp. 113 and 114).

In the electrolyte according to the invention, depending on the application, anionic and nonionic surfactants can typically be used as wetting agents, such as, for example, polyethylene glycol adducts, fatty alcohol sulfates, alkyl sulfates, alkyl sulfonates, aryl sulfonates, alkylaryl sulfonates, heteroaryl sulfates, betaines, fluorosurfactants and salts and derivatives thereof (see also: Kanani, N: Galvanotechnik; Hanser Verlag, Munich Vienna, 2000; pp. 84 ff). The use of a methanesulfonate salt, in particular potassium salt, is preferred.

In a further embodiment, the present invention relates to the use of the alloy layer according to the invention in electrical contact materials as an end layer or as an intermediate layer in order to increase the corrosion resistance of the contact materials. The preferred embodiments for the alloy layer apply mutatis mutandis also to its use.

By the addition of certain additional metals, such as Bi, Pb, Ce or In, to an AgPdTe alloy, recognizable advantages are obtained in the electrolytic deposition. The working range of the electrolyte is significantly increased. Crack-free deposits can be deposited under the same deposition conditions at significantly higher current densities and with significantly higher layer thicknesses. At the same time, the alloy composition of these layers is stable over a large operating range which is, of course, a significant advantage for high-speed deposition. The alloy itself is significantly harder and thus predestined for use in contact materials. This was not evident to the person skilled in the art on the priority date.

### EXAMPLES

Deposition conditions, beaker test, aqueous electrolyte according to DE102013215476B3:

100 ml/l methanesulfonic acid 70%

2 g/l amino acid

20 g/l silver (as soluble silver salt)

12 g/l palladium (as soluble palladium salt)

500 mg/l tellurium (as salt of a tellurous acid)

30 g/l methanesulfonate salt

65° C./300 rpm 6 cm/PtTi anodes

Deposition conditions, beaker test, electrolyte according to the invention:

100 ml/l methanesulfonic acid 70%

2 g/l amino acid

20 g/l silver (as soluble silver salt)

12 g/l palladium (as soluble palladium salt)

300 mg/l alloy metal (cerium, bismuth, lead, indium) (as soluble salt)

500 mg/l tellurium (as salt of a tellurous acid)

30 g/l of methanesulfonate salt

Both electrolytes with a pH of <1 were initially charged at 65° C. The stirring speed was 300 rpm with a 6 cm magnetic stirrer and a product movement at a speed of 6 cm/s was used. The experiments were carried out in a beaker on a 1I scale. PtTi anodes were used. The substrate used was a Cu substrate pre-coated with Ni and gold. The electrolyte density was 1.1 g/cm³ (23° C.). It was electrolyzed at various current densities (see Table 1).

Deposition results:

TABLE 1
Comparison of old and new electrolyte with respect to cracking
and alloy composition at different current densities.

| | i | [%] | [%] | [%] | [%] | AZ | R 180° C. |
|---|---|---|---|---|---|---|---|
| Electrolyte | [A/dm²] | Ag | Pd | Te | Bi | cracks | 120 min |
| Old | 1 | 87 | 9.5 | 3.5 | X | crack-free | cracks |
| Old | 4 | 92.5 | 4.5 | 3.0 | X | crack-free | cracks |
| Old | 6 | 93.5 | 4.0 | 2.5 | X | cracks | cracks |
| New | 1 | 92.6 | 4.1 | 2.4 | 0.9 | crack-free | crack-free |
| New | 4 | 91.9 | 3.7 | 3.1 | 1.3 | crack-free | crack-free |
| New | 6 | 91.2 | 4.6 | 3.0 | 1.1 | crack-free | crack-free |

By adding, for example, Bi, Ce, Pb, or In salts to an electrolyte for the deposition of AgPdTe alloys predominantly containing silver, the working range of the electrolyte is significantly increased. Crack-free deposits can be deposited under the same deposition conditions at significantly higher current densities and with significantly higher layer thicknesses. At the same time, the alloy composition of these layers is stable over a large operating range which is a significant advantage for high-speed deposition. Furthermore, the alloy according to the invention exhibits improved abrasion resistance and hardness properties. The hardness increases from 250 Hv to 300 Hv when adding, for example, 1.5 at % Bi.

1. An electrolytically deposited silver palladium alloy layer predominantly containing predominantly silver, and comprising less than or equal to 20 at % tellurium relative to the entire alloy layer, and one or more metals selected from the group consisting of Ce, Dy, Pb, Bi, AI, Ga, Ge, Fe, In, Co, Ni, Cu, Sn, Sb, Rh, Ru, Ir, Pt, and Au.

2. The alloy layer according to claim 1, wherein the additional metal or metals are present in an amount of less than or equal to 40 at % in the alloy layer.

3. The alloy layer according to claim 1, wherein silver is contained in the alloy layer in an amount greater than 60 at %.

4. The alloy layer according to claim 1, wherein palladium is present in an amount of 0.1-30 at % in the alloy layer.

5. The alloy layer according to claim 1, wherein tellurium is present in an amount of 0.1-10 at % in the alloy layer.

6. The alloy layer according to claim 1, wherein it has a hardness of >250 Hv.

7. A method for the electrolytic deposition of a silver-palladium alloy layer predominantly containing silver and having less than or equal to 20 at % tellurium relative to the entire alloy layer, wherein an aqueous, acidic and cyanide-free electrolyte having the following composition is used:
a) a soluble silver salt
b) a soluble palladium salt,
c) a soluble tellurium salt in which tellurium has the oxidation state +4 or +6,
d) a soluble salt of one or more of the metals selected from the group consisting of Ce, Dy, Pb, Bi, AI, Ga, Ge, Fe, In, Co, Ni, Cu, Sn, Sb, Rh, Ru, Ir, Pt, and Au
e) at least one amino acid selected from the group consisting of:
alanine, aspartic acid, cysteine, glutamine, glutamic acid, glycine, lysine, leucine, methionine, phenylalanine, phenylglycine, proline, serine, tyrosine, and valine.

8. The method according to claim 7, wherein the pH value of the electrolyte during the electrolytic deposition is below 2.

9. The method according to claim 1, wherein the electrolyte density is between 1.0 and 1.5 at 23° C.

10. The method according to claim 1, wherein the current density during the electrolytic deposition is between 0.1 and 100 A/dm2, depending on the coating method and plant technology.

11. The method according to claim 1, wherein the electrolytic deposition is carried out at temperatures of 30° C. to 90° C.

12. A method of increasing corrosion resistance of an electrical contact material, which comprises applying the alloy layer according to claim 1 to the contact material.

13. The method according to claim 12, wherein the alloy layer is applied as an end layer or as an intermediate layer.
